(19) United States
(12) Patent Application Publication
(10) Pub. No.: US 2005/0278153 A1
(43) Pub. Date: Dec. 15, 2005

(54) Detecting vacuously satisfield specifications in model checking

(76) Inventors: Roy Armoni, Givat Ada (IL); Limor Fix, Zichron Yaakov (IL); Alon Flaisher, Haifa (IL); Nir Piterman, Rehovot (IL); Andreas Tiemeyers, Oxford (GB); Moshe Y. Vardi, Bellaire, TX (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/853,526

(22) Filed: May 25, 2004

(51) Int. Cl. G06F 17/50; G06F 9/45

(52) U.S. Cl. 703/2; 716/4; 716/5

(57) ABSTRACT

Modifying a specification of a design by replacing a sub formula of the specification with a free variable; model checking the modified specification in a model to determine whether the modified specification is satisfied in the model; and determining whether the sub formula affects satisfaction of the specification in the model based on determining whether the modified specification is satisfied in the model.

### BACKGROUND

Formal verification of hardware designs such as integrated circuit designs is an important part of the hardware design process. One specific type of formal verification is termed model checking. In model checking, a representation of the hardware design called a model is constructed and represented, for example, as a finite state machine within a computer program or alternatively in the memory of a specialized hardware device. The program or device is termed a model checker. A property of the design is expressed as a formula in a computer readable specification language or in some other digital form acceptable to the model checker. The model checker then may run an algorithm and provide verification that the given specification is true for the given model, also known as proving that the specification is satisfied in the model.

One type of model and specification system uses a temporal logic formula to encode system properties and behavior as a specification. Model checkers that use temporal logic are well known in the art. See, for example, the technique described in J. R. Burch, E. M. Clarke, K. L. McMillan, D. L. Dill, and J. Hwang, Symbolic model checking: 10\hat{ }20 states and beyond, Information and Computation, vol. 98, no. 2, June 1992, pp. 142-170, and R. Gerth, D. Peled, M. Vardi and P. Wolper, Simple On-the-fly Automatic Verification of Linear Temporal Logic, Proceedings of the Fifteenth International Symposium on Protocol Specification, Testing and Verification (PSTV), Chapman & Hall, 1995, pp. 3-19.

An example of an implementation of a temporal logic based model checker is the SMV model checker, available publicly from the Carnegie-Mellon University.

One advantage of model checkers that use temporal logic is that when a model checker attempts to prove the validity of a particular temporal logic formula that specifies a design, and the checker proves the specification is not satisfied in the model, it also provides a specific counterexample—a specific instance in the model and correspondingly in the design at which the provided specification is invalid. This may allow a designer to focus on the exact problem with the design that causes it to fail to satisfy the given specification.

However, an erroneous situation can also arise when a model checker reports that a specification expressed as a temporal logic formula is valid for a model. This may occur if the model satisfies the specification in an unintended way. In such a case, the model checker may report that the model satisfies the specification and will not indicate a problem or either design or specification. One type of case where this may occur is a case where a specification is vacuously satisfied in the model. In a general sense, a specification, expressed as a temporal logic formula, is said to be vacuously satisfied in a model if for some sub formula of the formula, satisfaction in the model does not depend on the sub formula.

More formally, a temporal logic formula FORM is satisfied in a system M vacuously if it is satisfied in M, but some sub formula SUB of FORM does not affect FORM in M. SUB does not affect FORM in M if FORM [SUB<-SUB 1] is also satisfied in M for all formulas SUB1 (here, FORM [SUB<- SUB1] denotes the result of substituting SUB1 for SUB in FORM)

As an example, consider a typical temporal logic specification G(REQ->ACK) (loosely, REQ is always followed by ACK) for a system in which REQ is never true. In such a system, the above specification is vacuously true.

In a practical sense, it is important for a designer to know that a specification that is validated by a model checker is vacuously satisfied by the design represented by the model, because in such a case, there is generally likely to be either a discrepancy between the intent of the designers and the actual specification, or between the intent of the designers as expressed in the specification, and the actual design behavior. Vacuity detection in which sub formulas that do not affect a specification are identified may be useful in pinpointing the reasons that make a design vacuously satisfy a specification. A sub formula that does not affect a specification and is identified by a vacuity detection system for vacuously valid specifications, is in this sense similar to a counterexample provided by model checkers for invalid specifications.

Existing vacuity detection systems work with single instance sub formulas. These systems allow detection of vacuous specification with respect to sub formulas that do not affect the satisfaction of the specification in a model, when the sub formula occurs exactly once in the specification. Other existing vacuity detection systems work only with unipolar sub formulas. A sub formula is unipolar when it is always found in either positive (un-negated) or negative (negated) polarity in a formula, but not both. For such systems, see for example, I. Beer, S. Ben-Davi, C. Eisner, Y. Rodeh, Efficient detection of vacuity in ACTL formulas. Formal Methods in System Design, 18 (2), p. 141-162, 2001, and O. Kupferman, M. Vardi, Vacuity detection in temporal model checking, 10^{th} Advanced Research Working Conference on Correct Hardware Design and Verification Methods, LNCS vol. 1793, Springer Verlag, 1999.

In formulas where a sub formula has multiple occurrences and is not unipolar, the sub formula is said to have mixed polarity.

### BRIEF DESCRIPTION OF THE DRAWINGS

FIG. 1 depicts a flowchart of one embodiment.

FIG. 2 depicts a processor based system.

### DETAILED DESCRIPTION

In one embodiment, a model is constructed to represent a design using a language based on a linear temporal logic as an input format, such as the ForSpec linear temporal logic specification language which is used in the circuit design industry by Intel® Corporation of Santa Clara, Calif., and others. ForSpec is described in R. Armoni, L. Fix, A. Flaisher, R. Gerth, B. Ginsburg, T. Kanza, A. Landver, S. Mador-Haim, E. Singerman, A. Tiemeyer, M. Y. Vardi, and Y. Zbar, The For-Spec temporal logic: A new temporal property-specification language, 8th TACAS, LNCS 2280, 296-211, 2002. Springer. The language is used in one embodiment with the BDD-based model checker Forecast, described at R. Fraer, G. Kamhi, B. Ziv, M. Vardi, and L. Fix, Prioritized traversal: efficient reachability analysis for verication and falsification, 12th CAV, LNCS 1855, 2000. In other embodiments, different specification languages based linear temporal logic may be used. Alternately, different model checkers may be used. Many different specification languages and specification languages based on linear temporal logic and other formal schemes for model checkers are known in the art. See for one alternative, the model checker SMV referenced above or for another alternative the model checker Thunder described in F. Copty, L. Fix, R. Fraer, E. Giunchiglia, G. Kamhi, A. Tacchella, and M. Y. Vardi, Benefits of bounded model checding at an industrial setting, Proc. 13th Conference on Computer Aided Verification, 2001.

In an industrial model checking language such as ForSpec, the additional expressive power of the specification language allows sub formulas of specifications in the language to have mixed polarity and indeed many sub formulas in real specifications of industrial designs have mixed polarity. A method to detect vacuity in model checkers that use ForSpec in these embodiments should therefore consider vacuity detection for sub formulas with mixed polarity.

In one embodiment, a model checker may run the mathematical algorithm provided in Table 1 below to determine vacuity. An alternative formulation of an algorithm similar to the mathematical representation of Table 1, but in a programmatic style in pseudocode is provided in Table 2 for further clarification. A flowchart of the processing is provided in FIG. 2.

TABLE 1
For specification φ, with sub formula φ, and model M

| | |
|---|---|
| 1. | Compute the polarity of ψ in φ |
| 2. | If ψ is of positive polarity, model check |
| | M \|= φ [ψ <- false] |
| 3. | If ψ is of negative polarity, model check |
| | M \|= φ [ψ <- true] |
| 4. | If ψ is of mixed polarity, |
| | add a free variable x to M and |
| | model check ∀x M+x \|= φ [ψ <- x] |
| 5. | If model checking passes, report that ψ does not affect φ. Else |
| | report that ψ affects φ. |

TABLE 2

```
// check if subformula sub_f affects the correctness of
// formula f on the model M
affects (model M, formula sub_f, formula f) {
  polarity := polarity of sub_f in f
  if (polarity = POSITIVE) {
    vac_f := in f, substitute sub_f with FALSE
  {
  if (polarity = NEGATIVE) {
    vac_f := in f, substitute sub_f with TRUE
  }
  if (polarity = MIXED) {
    create a free variable x
    M := add x to M
    vac_f := in f, substitute sub_f with x
  }
  if (vac_f is true in M) {
    return NO
  }
  else {
    return YES
  }
}
```

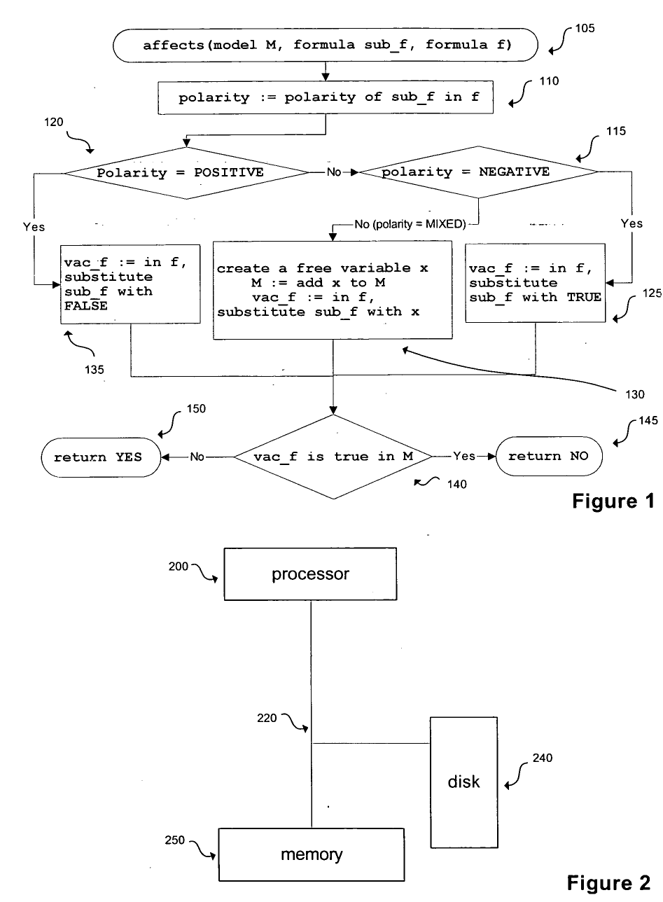

As may be seen from the algorithm defined in Table 1 and Table 2, and with reference to the flowchart equivalent in FIG. 1, a vacuity detection system may first attempt to cover the simpler case of a unipolar formula by substituting FALSE for a sub formula of positive polarity (at 120 and 135 in FIG. 1), or TRUE for a sub formula of negative polarity (as at 115 and 125 in FIG. 1). In the mixed polarity case (as at 130 in FIG. 1), the algorithm substitutes a free variable x for the sub formula after adding the free variable x to model M. If the modified specification is satisfied in the modified model (at 140 and 145 in FIG. 1), then the specification is vacuously satisfied in the model because the sub formula does not affect it. It may be noted that the “affects” procedure in the figure returns YES as at 150 in FIG. 1 when the modified sub formula is not true in M, that is, the sub formula sub_f affects the validity of f in M

The steps of substituting a free variable for a formula and adding a free variable to a model are well known in the art and are not detailed here.

In general, a system embodying the claimed subject matter may be implemented by a processor based system such as that depicted in FIG. 2. Such a system is a processor based system including a processor 200, a memory 250 to store data and programs executable by the processor, and a storage unit such as a disk system 240 all interconnected by a bus system 220. A program embodying the algorithms described herein may be stored on the disk system and loaded into memory via the bus system and executed by the processor on layout data which may also be stored on the disk system and optionally in memory. A widely available system such as an Intel® Xeon™ Processor based server system running the Linux operating system is one exemplary embodiment of a processor based system as depicted in the figure that may be used to execute a layout analysis tool in accordance with the claimed subject matter.

While certain exemplary embodiments of the invention have been described above and shown in the accompanying drawing, it is to be understood that such embodiments are merely illustrative of and not restrictive on the broad aspects of various embodiments of the invention, and that these embodiments not be limited to the specific constructions and arrangements shown and described, since various other modifications are possible. It is possible to implement the embodiments of the invention or some of their features in hardware, programmable devices, firmware, software or a combination thereof.

Embodiments in accordance with the claimed subject matter may be provided as a computer program product that may include a machine-readable medium having stored thereon data which when accessed by a machine may cause the machine to perform a process according to the claimed subject matter. The machine-readable medium may include, but is not limited to, floppy diskettes, optical disks, DVD-ROM disks, DVD-RAM disks, DVD−RW disks, DVD+RW disks, CD-R disks, CD-RW disks, CD-ROM disks, and magneto-optical disks, ROMs, RAMs, EPROMs, EEPROMs, magnet or optical cards, flash memory, or other type of media/machine-readable medium suitable for storing electronic instructions. Moreover, embodiments may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form but steps can be added to or deleted from any of the methods and information can be added or subtracted from any of the described messages without departing from the basic scope of the claimed subject matter. It will be apparent to those skilled in the art that many further modifications and adaptations can be made. The particular embodiments are not provided to limit the invention but to illustrate it. The scope of the claimed subject matter is not to be determined by the specific examples provided above but only by the claims below.

1. A method comprising:
modifying a specification of a design by replacing a sub formula of the specification with a free variable;
model checking the modified specification in a model to determine whether the modified specification is satisfied in the model; and
determining whether the sub formula affects satisfaction of the specification in the model based on determining whether the modified specification is satisfied in the model.

2. The method of claim 1 wherein the specification is a formula in a linear temporal logic language, the sub formula is a sub formula of the formula, and the modified specification is a modified formula in the linear temporal logic language obtained by replacing the sub formula of the formula with the free variable.

3. The method of claim 2 wherein determining whether the sub formula affects satisfaction of the specification in the model based on determining whether the modified specification is satisfied in the model, further comprises determining that the sub formula affects satisfaction of the formula in the model if and only if the modified formula is satisfied in the model.

4. The method of claim 3 wherein the specification is a formula in the ForSpec specification language.

5. The method of claim 3 wherein the model further comprises a model representing the design to which the free variable has been added.

6. A method comprising:
for a sub formula of a specification of a design
if the sub formula is of positive polarity, replacing the sub formula of the specification with the FALSE logic constant;
if the sub formula is of negative polarity, replacing the sub formula of the specification with the TRUE logic constant; and
if the sub formula is of mixed polarity, replacing a sub formula of the specification with a free variable;
model checking the modified specification in a model to determine whether the modified specification is satisfied in the model; and
determining whether the sub formula affects satisfaction of the specification in the model based on determining whether the modified specification is satisfied in the model.

7. The method of claim 6 wherein:
the specification is a formula in a linear temporal logic language;
the sub formula is a sub formula of the formula;
and the modified specification is a modified formula in the linear temporal logic language obtained by replacing the sub formula of the formula with the free variable.

8. The method of claim 7 wherein determining whether the sub formula affects satisfaction of the specification in the model based on determining whether the modified specification is satisfied in the model further comprises detemnining that the sub formula affects satisfaction of the formula in the model if and only if the modified formula is satisfied in the model.

9. The method of claim 8 wherein the specification is a formula in the ForSpec specification language.

10. The method of claim 8 wherein the model further comprises a model, representing the design, to which the free variable has been added.

11. A system comprising:
a processor to execute programs of the system;
a storage unit, communicatively coupled to the processor, to store programs of the system; and
a program of the system to perform a method, the method comprising:
modifying a specification comprising a formula in a linear temporal logic language for a design by replacing a sub formula of the formula with a free variable to obtain a modified formula in the linear temporal logic language;
model checking the modified formula in a model to determine whether the modified specification is satisfied in the model; and
determining whether the sub formula affects satisfaction of the specification in the model based on determining whether the modified specification is satisfied in the model.

12. The system of claim 11 wherein the model further comprises a model representing the design to which the free variable has been added.

13. A system comprising:
a processor to execute programs of the system;
a storage unit, communicatively coupled to the processor, to store programs of the system; and
a program of the system to perform a method, the method comprising:
for a sub formula of a formula in a linear temporal logic language specifying a design,
if the sub formula is of positive polarity, replacing the sub formula of the formula with the FALSE logic constant;
if the sub formula is of negative polarity, replacing the sub formula of the formula with the TRUE logic constant; and
if the sub formula is of mixed polarity, replacing a sub formula of the formula with a free variable
to obtain a modified formula in the linear temporal logic language;
model checking the modified formula in a model to determine whether the modified formula is satisfied in the model; and
determining whether the sub formula affects satisfaction of the formula in the model based on determining whether the modified formula is satisfied in the model.

14. The system of claim 13 wherein the model further comprises a model, representing the design, to which the free variable has been added.

15. A machine readable medium having stored thereon data which when accessed by a machine causes the machine to perform a method, the method comprising:
modifying a specification for a design comprising a formula in a linear temporal logic language by replacing a sub formula of the formula with a free variable to obtain a modified formula in the linear temporal logic language;
model checking the modified formula in a model to determine whether the modified formula is satisfied in the model; and
determining whether the sub formula affects satisfaction of the formula in the model based on determining whether the modified formula is satisfied in the model.

16. The machine readable medium of claim 15 wherein the model further comprises a model representing the design to which the free variable has been added.

17. The machine readable medium of claim 16 having stored thereon further data which when accessed by a machine causes the machine causes the machine to perform a method, the method comprising:
for a sub formula of a specification of a design comprising a formula in a linear temporal logic language
if the sub formula is of positive polarity, replacing the sub formula of the specification with the FALSE logic constant;
if the sub formula is of negative polarity, replacing the sub formula of the specification with the TRUE logic constant; and
if the sub formula is of mixed polarity, replacing a sub formula of the specification with a free variable to obtain a modified formula in the linear temporal logic language;
model checking the modified formula in a model to determine whether the modified formula is satisfied in the model; and
determining whether the sub formula affects satisfaction of the formula in the model based on determining whether the modified formula is satisfied in the model.

18. The machine readable medium of claim 17 wherein the specification is a formula in the ForSpec specification language.

19. The machine readable medium of claim 17 wherein the model further comprises a model, representing the design, to which the free variable has been added.
